(19) United States
(12) Patent Application Publication
(10) Pub. No.: US 2021/0002507 A1
(43) Pub. Date: Jan. 7, 2021

(54) LIQUID CRYSTALLINE POLYESTER LIQUID COMPOSITION, METHOD FOR MANUFACTURING LIQUID CRYSTALLINE POLYESTER FILM, AND LIQUID CRYSTALLINE POLYESTER FILM

(71) Applicant: SUMITOMO CHEMICAL COMPANY, LIMITED, Tokyo (JP)

(72) Inventors: Shohei AZAMI, Tsukuba-shi (JP); Toyonari ITO, Tokyo (JP)

(21) Appl. No.: 16/980,749

(22) PCT Filed: Mar. 18, 2019
(86) PCT No.: PCT/JP2019/011188

§ 371 Date: Sep. 14, 2020

(30) Foreign Application Priority Data
Mar. 20, 2018 (JP) 2018-053413

(51) Int. Cl. C09D 167/04; C09D 5/00

(52) U.S. Cl. CPC C09D 167/04; C09D 5/00

(57) ABSTRACT

A liquid crystalline polyester liquid composition containing a liquid crystalline polyester (A) that is soluble in an aprotic solvent, a liquid crystalline polyester (B) that is insoluble in an aprotic solvent, and an aprotic solvent (S), wherein the liquid crystalline polyester (A) and the liquid crystalline polyester (B) are liquid crystalline polyesters that have a structural unit derived from a hydroxycarboxylic acid as a mesogenic group.

### TECHNICAL FIELD

The present invention relates to a liquid crystalline polyester liquid composition, a method for manufacturing a liquid crystalline polyester film, and a liquid crystalline polyester film.

Priority is claimed on Japanese Patent Application No. 2018-053413, filed Mar. 20, 2018, the contents of which are incorporated herein by reference.

### BACKGROUND ART

In printed circuit boards on which electronic components are mounted, the density of the circuit patterns continues to increase. For example, in insulating materials for flexible copper-clad laminates, improvements in physical properties such as the dielectric characteristics and the dielectric loss tangent are becoming increasingly desirable.

For example, Patent Document 1 discloses an insulating resin composition containing an epoxy resin containing silyl groups, a curing agent and a filler with the object of reducing the dielectric loss. In Patent Document 1, an inorganic filler such as silica is used as the filler.

### CITATION LIST

### Patent Document

Patent Document 1: JP 2017-66360-A

### SUMMARY OF THE INVENTION

### Problems to be Solved by the Invention

When an inorganic filler is added to a resin composition as per the method disclosed in Patent Document 1, problems arise in that the adhesive strength to metal foils and the mechanical strength of the insulating base material tend to decrease.

The present invention has been developed in light of these circumstances, and has the objects of providing a liquid crystalline polyester liquid composition capable of producing a film having a low dielectric loss tangent without impairing the adhesive strength to metal foils or the mechanical strength, a method for manufacturing a liquid crystalline polyester film, and a liquid crystalline polyester film.

### Means to Solve the Problems

That is, the present invention includes the following aspects [1] to [12].

[1] A liquid crystalline polyester liquid composition comprising a liquid crystalline polyester (A) that is soluble in an aprotic solvent, a liquid crystalline polyester (B) that is insoluble in an aprotic solvent, and an aprotic solvent (S), wherein the liquid crystalline polyester (A) and the liquid crystalline polyester (B) are liquid crystalline polyesters that have a structural unit derived from a hydroxycarboxylic acid as a mesogenic group.
[2] The liquid crystalline polyester liquid composition according to [1], wherein the liquid crystalline polyester (A) and the liquid crystalline polyester (B) each contain a structural unit derived from p-hydroxybenzoic acid or 6-hydroxy-2-naphthoic acid.
[3] The liquid crystalline polyester liquid composition according to [1] or [2], wherein the liquid crystalline polyester (A) contains a structural unit represented by formula (A1) shown below, a structural unit represented by formula (A2) shown below, and a structural unit represented by formula (A3) shown below, and

relative to the total amount of all the structural units that constitute the liquid crystalline polyester (A), the amount of the structural unit represented by formula (A1) is at least 30 mol % but not more than 80 mol %, the amount of the structural unit represented by formula (A2) is at least 10 mol % but not more than 35 mol %, and the amount of the structural unit represented by formula (A3) is at least 10 mol % but not more than 35 mol %.

—O-Ar1-CO— (A1)

—CO-Ar2-CO— (A2)

—X-Ar3-Y— (A3)

(In the formulas, Ar1 represents a 1,4-phenylene group, 2,6-naphthalenediyl group or 4,4′-biphenylene group, Ar2 represents a 1,4-phenylene group, 1,3-phenylene group or 2,6-naphthalenediyl group, Ar3 represents a 1,4-phenylene group or 1,3-phenylene group. X represents —NH—, and Y represents —O— or NH—)
[4] The liquid crystalline polyester liquid composition according to any one of [I] to [3], wherein the liquid crystalline polyester (B) contains a naphthalene structure in a structural unit.
[5] The liquid crystalline polyester liquid composition according to any one of [1] to [4], wherein the liquid crystalline polyester (B) contains a structural unit represented by formula (B1) shown below, a structural unit represented by formula (B2) shown below, and a structural unit represented by formula (B3) shown below,

at least one structural unit selected from the group consisting of the structural unit represented by formula (B1), the structural unit represented by formula (B2) and the structural unit represented by formula (B3) contains a naphthalene structure,

the naphthalene structure is a 2,6-naphthalenediyl group, and

the amount of 2,6-naphthalenediyl groups, relative to the total amount of all groups represented by Ar4, Ar5 and Ar6 shown below, is at least 40 mol %.

—O-Ar4-CO— (B1)

—CO-Ar5-CO— (B2)

—O-Ar6-O— (B3)

(Ar4 represents a 2,6-naphthalenediyl group, 1,4-phenylene group or 4,4′-biphenylylene group; Ar5 represents a 2,6-naphthalenediyl group, 1,4-phenylene group, 1,3-phenylene group or 4,4′-biphenylylene group; and Ar6 represents a 2,6-naphthalenediyl group, 1,4-phenylene group, 1,3-phenylene group or 4,4′-biphenylylene group; provided that at least one group selected from the group consisting of the group represented by Ar4, the group represented by Ar5 and the group represented by Ar6 includes a 2,6-naphthalenediyl group; and hydrogen atoms in the groups represented by Ar4, Ar5 or Ar6 may each be independently substituted with a halogen atom, an alkyl group of 1 to 10 carbon atoms, or an aryl group of 6 to 20 carbon atoms)
[6] The liquid crystalline polyester liquid composition according to any one of [I] to [5], wherein Ar1 is a 2,6-naphthalenediyl group, Ar2 is a 1,3-phenylene group, Ar3 is a 1,4-phenylene group, and Y is —O—.
[7] The liquid crystalline polyester liquid composition according to any one of [1] to [6], wherein the amount of the liquid crystalline polyester (B), relative to the total amount of the liquid crystalline polyester (A) and the liquid crystalline polyester (B) contained in the liquid crystalline polyester liquid composition, is at least 5% by mass but not more than 70% by mass.
[8] The liquid crystalline polyester liquid composition according to any one of [1] to [7], wherein the total amount of the liquid crystalline polyester (A) and the liquid crystalline polyester (B), per 100 parts by mass of the aprotic solvent (S), is at least 0.01 parts by mass but not more than 100 parts by mass.
[9] The liquid crystalline polyester liquid composition according to any one of [1] to [8], wherein the aprotic solvent (S) is N-methylpyrrolidone.
[10] The liquid crystalline polyester liquid composition according to any one of [1] to [9], wherein the liquid crystalline polyester (B) is a powder having a volume average particle diameter of at least 0.1 μm but not more than 30 μm.
[11] A method for manufacturing a liquid crystalline polyester film, comprising

flow casting the liquid crystalline polyester liquid composition according to any one of [1] to [10] onto a metal foil,

obtaining a laminated body having the metal foil and a liquid crystalline polyester film precursor by removing the solvent from the flow cast liquid crystalline polyester liquid composition, and

obtaining a laminated body having the metal foil and a liquid crystalline polyester film by subjecting the laminated body obtained following solvent removal to a heat treatment.

[12] A liquid crystalline polyester film comprising a liquid crystalline polyester (A) that is soluble in an aprotic solvent and a liquid crystalline polyester (B) that is insoluble in an aprotic solvent, wherein the liquid crystalline polyester (B) is dispersed in the liquid crystalline polyester (A).

### Effects of the Invention

The present invention can provide a liquid crystalline polyester liquid composition capable of producing a film having a low dielectric loss tangent without impairing the adhesive strength to metal foils or the mechanical strength, a method for manufacturing a liquid crystalline polyester film, and a liquid crystalline polyester film.

### BRIEF DESCRIPTION OF DRAWINGS

FIG. 1 is a graph illustrating the relationship between the amounts added of the component (B) and the like and the peel strength.

FIG. 2 is a graph illustrating the relationship between the amounts added of the component (B) and the like and the maximum point stress.

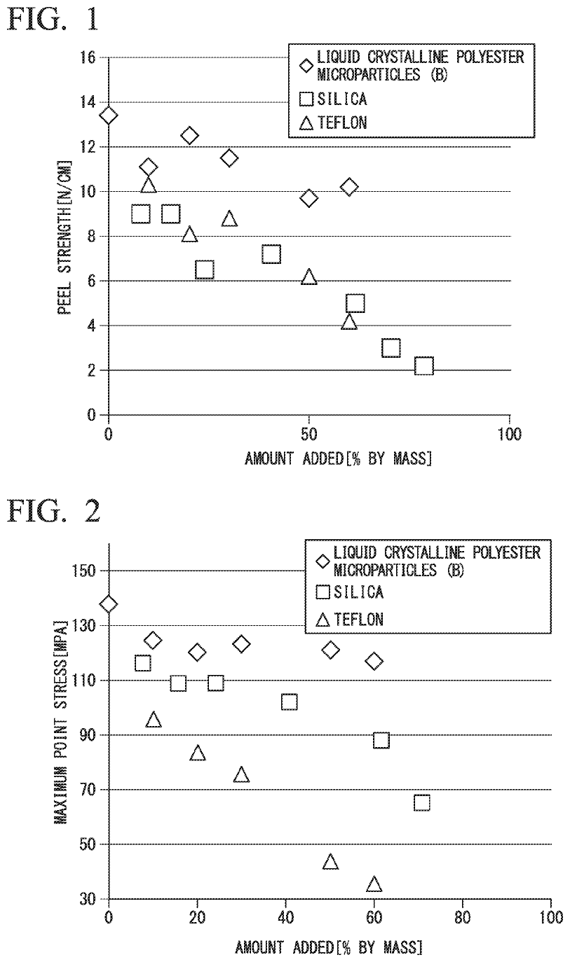

### EMBODIMENTS FOR CARRYING OUT THE INVENTION

### <Liquid Crystalline Polyester Liquid Composition>

A liquid crystalline polyester liquid composition of an embodiment of the present invention comprises a liquid crystalline polyester (A) that is soluble in an aprotic solvent (hereinafter sometimes referred to as “component (A)”), a liquid crystalline polyester (B) that is insoluble in an aprotic solvent (hereinafter sometimes referred to as “component (B)”), and an aprotic solvent (S) (hereinafter sometimes referred to as “component (S)”).

In this embodiment, the liquid crystalline polyester (A) and the liquid crystalline polyester (B) are liquid crystalline polyesters that have a structural unit derived from a hydroxycarboxylic acid as a mesogenic group. Here, a “mesogenic group” describes a rigid structural unit in which a plurality of cyclic structures such as benzene rings are bonded in a linear manner (Naoyuki Koide, Kunisuke Sakamoto: Liquid Crystal Polymers, published by Kyoritsu Shuppan Co., Ltd., 1998).

In this embodiment, the liquid crystalline polyester (A) and the liquid crystalline polyester (B) each preferably contain a structural unit derived from p-hydroxybenzoic acid or 6-hydroxy-2-naphthoic acid.

### <<Component (A)>>

The component (A) is a liquid crystalline polyester that is soluble in an aprotic solvent. Whether the polyester is “soluble in an aprotic solvent” can be confirmed by conducting the following test.

### —Test Method

The liquid crystalline polyester is stirred for L to 6 hours in an aprotic solvent at a temperature of 120° C. to 180° C., and the solution is then cooled to room temperature (23° C.). Subsequently, the solution is filtered using a 5 μm membrane filter and a pressurized filtration device, and the presence of any residue on the membrane filter is ascertained. If no solid matter is noticeable at this time, the liquid crystalline polyester is deemed to be soluble in the aprotic solvent.

More specifically, 1 part by mass of the liquid crystalline polyester is stirred at 140° C. for 4 hours in 99 parts by mass of an aprotic solvent (namely, the solvent contained in the liquid crystalline polyester liquid composition), and the solution is then cooled to 23° C. Subsequently, the solution is filtered using a 5 μm membrane filter and a pressurized filtration device, and the presence of any residue on the membrane filter is ascertained. If no solid matter is noticeable at this time, the liquid crystalline polyester is deemed to be soluble in the aprotic solvent.

The liquid crystalline polyester (A) preferably contains structural units represented by formulas (A1), (A2) and (A3) shown below as structural units.

In one aspect, relative to the total amount of all the structural units that constitute the component (A), the amount of the structural unit represented by formula (A1) is from 30 to 80 mol %, the amount of the structural unit represented by formula (A2) is from 35 to 10 mol %, and the amount of the structural unit represented by formula (A3) is from 35 to 10 mol %.

However, the total amount of the structural unit represented by formula (A1), the structural unit represented by formula (A2) and the structural unit represented by formula (A3) does not exceed 100 mol %.

—O-Ar1-CO— (A1)

—CO-Ar2-CO— (A2)

—X-Ar3-Y— (A3)

(Here, Ar1 represents a 1,4-phenylene group, 2,6-naphthalenediyl group or 4,4′-biphenylene group. Ar2 represents a 1,4-phenylene group, 1,3-phenylene group or 2,6-naphthalenediyl group. Ar3 represents a 1,4-phenylene group or 1,3-phenylene group. X represents —NH—, and Y represents —O— or NH—.)

The structural unit (A1) is a structural unit derived from an aromatic hydroxycarboxylic acid, the structural unit (A2) is a structural unit derived from an aromatic dicarboxylic acid, and the structural unit (A3) is a structural unit derived from an aromatic diamine or an aromatic amine having a phenolic hydroxyl group. The component (A) may use an ester- or amide-forming derivative of any of the above structural units instead of the above structural units.

In this description, “derived” means a change in the chemical structure due to polymerization.

In this embodiment, it is preferable that Ar1 is a 2,6-naphthalenediyl group, Ar2 is a 1,3-phenylene group, Ar3 is a 1,4-phenylene group, and Y is —O—.

Examples of ester-forming derivatives of carboxylic acids include derivatives in which the carboxyl group has been replaced with an acid chloride or a highly reactive group such as an acid anhydride group that promotes the reaction that produces a polyester, and derivatives which form an ester with an alcohol or ethylene glycol or the like, such that the carboxyl group produces a polyester via a transesterification.

Examples of ester-forming derivatives of a phenolic hydroxyl group include derivatives in which the phenolic hydroxyl group forms an ester with a carboxylic acid.

Examples of amide-forming derivatives of an amino group include derivatives in which the amino group forms an amide with a carboxylic acid.

Examples of the repeating structural units of the component (A) used in the present embodiment include, but are not limited to, those described below.

Examples of structural units represented by formula (A1) include structural units derived from p-hydroxybenzoic acid, 6-hydroxy-2-naphthoic acid or 4′-hydroxy-4-biphenylcarboxylic acid, and two or more types of these structural units may be included within the total of all the structural units. Among these structural units, use of a component (A) that includes a structural unit derived from 6-hydroxy-2-naphthoic acid is preferable.

The amount of the structural unit (A1), relative to the amount of all the structural units that constitute the component (A), is at least 30 mol % but not more than 80 mol %, preferably at least 40 mol % but not more than 70 mol %, and more preferably at least 45 mol % but not more than 65 mol %.

If the amount of the structural unit (A1) is large, then the solubility in solvents tends to deteriorate markedly, whereas if the amount is too small, the polyester tends to not exhibit liquid crystallinity. In other words, provided the amount of the structural unit (A1) falls within the above range, the solubility in solvents is favorable, and the polyester exhibits liquid crystallinity more readily.

Examples of structural units represented by formula (A2) include structural units derived from terephthalic acid, isophthalic acid or 2,6-naphthalenedicarboxylic acid, and two or more types of these structural units may be included within the total of all the structural units. Among these structural units, from the viewpoint of the solubility in solvents, use of a liquid crystalline polyester containing a structural unit derived from isophthalic acid is preferable.

The amount of the structural unit (A2), relative to the amount of all the structural units that constitute the component (A), is preferably at least 10 mol % but not more than 35 mol %, more preferably at least 15 mol % but not more than 30 mol %, and particularly preferably at least 17.5 mol % but not more than 27.5 mol %. If the amount of the structural unit (A2) is too large, then the liquid crystallinity tends to deteriorate, whereas if the amount is small, the solubility in solvents tends to deteriorate. In other words, provided the amount of the structural unit (A2) falls within the above range, the liquid crystallinity is favorable, and the solubility in solvents is also favorable.

Examples of structural units represented by formula (A3) include structural units derived from 3-aminophenol, 4-aminophenol, 1,4-phenylenediamine or 1,3-phenylenediamine, and two or more types of these structural units may be included within the total of all the structural units. Among these structural units, from the viewpoint of reactivity, use of a liquid crystalline polyester containing a structural unit derived from 4-aminophenol is preferable.

The amount of the structural unit (A3), relative to the amount of all the structural units that constitute the component (A), is preferably at least 10 mol % but not more than 35 mol %, more preferably at least 15 mol % but not more than 30 mol %, and particularly preferably at least 17.5 mol % but not more than 27.5 mol %. If the amount of the structural unit (A3) is too large, then the liquid crystallinity tends to deteriorate, whereas if the amount is small, the solubility in solvents tends to deteriorate. In other words, provided the amount of the structural unit (A3) falls within the above range, the liquid crystallinity is favorable, and the solubility in solvents is also favorable.

The structural unit (A3) is preferably used in an amount that is substantially equal to that of the structural unit (A2), but by varying the amount of the structural unit (A3) within a range from −10 mol % to ±10 mol % relative to the amount of the structural unit (A2), the degree of polymerization of the liquid crystalline polyester can be controlled.

There are no particular limitations on the method for manufacturing the component (A) of the present embodiment, but examples include methods in which an acylated product obtained by conducting an acylation of the phenolic hydroxyl group and amino group of an aromatic hydroxy acid corresponding with the structural unit (A1) and an aromatic amine having a phenolic hydroxyl group or an aromatic diamine corresponding with the structural unit (A3) in an excess of a fatty acid anhydride, and an aromatic dicarboxylic acid corresponding with the structural unit (A2) are subjected to a melt polymerization by an transesterification-transamidation (polycondensation) (for example, see JP-2002-220444-A and JP-2002-146003-A).

In the acylation reaction, the amount added of the fatty acid anhydride, relative to the total amount of phenolic hydroxyl groups and amino groups, is preferably from 1.0 to 1.2 equivalents, and more preferably from 1.05 to 1.1 equivalents. If the amount added of the fatty acid anhydride is too small, then the acylated product and the raw material monomer and the like tend to undergo sublimation during the transesterification-transamidation (polycondensation), increasing the likelihood of blockages of the reaction system, whereas if the amount added is too large, then coloration of the obtained liquid crystalline polyester tends to become marked. In other words, provided the amount added of the fatty acid anhydride falls within the above range, the reaction between the acylated product and the raw material monomer and the like during transesterification-transamidation (polycondensation) proceeds favorably, and the obtained liquid crystalline polyester does not undergo excessive coloration.

The acylation reaction is preferably conducted at 130 to 180° C. for 5 minutes to 10 hours, and is more preferably conducted at 140 to 160° C. for 10 minutes to 3 hours.

There are no particular limitations on the fatty acid anhydride used in the acylation reaction, and examples include acetic anhydride, propionic anhydride, butyric anhydride, isobutyric anhydride, valeric anhydride, pivalic anhydride, 2-ethylhexanoic anhydride, monochloroacetic anhydride, dichloroacetic anhydride, trichloroacetic anhydride, monobromoacetic anhydride, dibromoacetic anhydride, tribromoacetic anhydride, monofluoroacetic anhydride, difluoroacetic anhydride, trifluoroacetic anhydride, glutaric anhydride, maleic anhydride, succinic anhydride and β-bromopropionic anhydride, and a mixture of two or more of these acid anhydrides may be used. In the present embodiment, acetic anhydride, propionic anhydride, butyric anhydride and isobutyric anhydride are preferable, and acetic anhydride is more preferable.

In the transesterification-transamidation (polycondensation), the amount of acyl groups within the acylated product is preferably 0.8 to 1.2 equivalents relative to the amount of carboxyl groups.

The transesterification-transamidation (polycondensation) is preferably performed while increasing the temperature to 400° C. at a rate of 0.1 to 50° C./minute, and is more preferably performed while increasing the temperature to 350° C. at a rate of 0.3 to 5° C./minute.

When conducting the transesterification-transamidation (polycondensation) of the acylated product and the carboxylic acid, the by-product fatty acid and unreacted fatty acid anhydride are preferably removed from the system by evaporation or the like.

The acylation reaction and the transesterification-transamidation (polycondensation) may be conducted in the presence of a catalyst. Conventional catalysts that are known as catalysts for polyester polymerization can be used as the catalyst, and examples include metal salt catalysts such as magnesium acetate, stannous acetate, tetrabutyl titanate, lead acetate, sodium acetate, potassium acetate and antimony trioxide, and organic compound catalysts such as N,N-dimethylaminopyridine and N-methylimidazole.

Among these catalysts, a heterocyclic compound containing at least two nitrogen atoms such as N,N-dimethylaminopyridine or N-methylimidazole can be used favorably (see JP-2002-146003-A).

The catalyst is usually added when the monomers are added, and need not necessarily be removed following the acylation, and in those cases where the catalyst is not removed, the transesterification can be performed immediately.

Polycondensation via the above transesterification-transamidation is usually performed by melt polymerization, but a combination of melt polymerization and solid phase polymerization may also be used. The solid phase polymerization is preferably performed by extracting the polymer from the melt polymerization step, subsequently grinding the polymer to produce a powder or flake form, and then using a conventional solid phase polymerization method. Specifically, the solid phase polymerization can be conducted, for example, by performing a heat treatment in a solid phase state for 1 to 30 hours, at a temperature of 20 to 350° C. and under an inert atmosphere of nitrogen or the like. The solid phase polymerization may be performed under stirring, or may be performed in a still state without stirring. By fitting an appropriate stirring mechanism, the melt polymerization tank and the solid phase polymerization tank can employ the same reaction tank. Following the solid phase polymerization, the obtained liquid crystalline polyester may be pelletized and molded using a conventional method. Further, the liquid crystalline polyester may also be ground using a conventional method.

Production of the liquid crystalline polyester may be conducted, for example, using a batch apparatus or a continuous apparatus or the like.

In those cases where the liquid crystalline polyester (A) is converted to powdered form, the volume average particle diameter is preferably within a range from 100 to 2,000 μm. The volume average particle diameter of the powdered liquid crystalline polyester (A) can be measured using a dry sieving method (for example, RPS-105 manufactured by Seishin Enterprise Co., Ltd.).

In one aspect, the amount of the component (A), relative to the total mass of the liquid crystalline polyester liquid composition, is preferably from 5 to 10% by mass.

### <<Component (B)>>

The liquid crystalline polyester (B) that is insoluble in an aprotic solvent preferably includes a naphthalene structure in a structural unit.

Whether or not the polyester is “insoluble in an aprotic solvent” can be confirmed using the same method as the test method described above. In other words, in the above test method, when a residue is confirmed on the membrane filter, if solid matter is confirmed, then the polyester is deemed to be insoluble in the aprotic solvent.

Examples of the above naphthalene structure include a 2,6-naphthalenediyl group.

In one aspect, the liquid crystalline polyester (B) preferably has a structural unit represented by formula (B1) shown below, a structural unit represented by formula (B2) shown below, and a structural unit represented by formula (B3) shown below,

Further, at least one structural unit selected from the group consisting of the structural unit represented by formula (B1) shown below, the structural unit represented by formula (B2) shown below and the structural unit represented by formula (B3) shown below contains a naphthalene structure, and the naphthalene structure is preferably a 2,6-naphthalenediyl group.

In the following description, a structural unit represented by formula (B1) shown below is sometimes referred to as the structural unit (B1). A structural unit represented by formula (B2) shown below is sometimes referred to as the structural unit (B2). A structural unit represented by formula (B3) shown below is sometimes referred to as the structural unit (B3). In the component (B) in the present embodiment, the amount of 2,6-naphthalenediyl groups, relative to the total amount of all groups represented by Ar4, Ar5 and Ar6 shown below, is preferably at least 40 mol %, and the flow start temperature is preferably at least 260° C., and more preferably 280° C. or higher.

—O-Ar4-CO— (B1)

—CO-Ar5-CO— (B2)

—O-Ar6-O— (B3)

(Ar4 represents a 2,6-naphthalenediyl group, 1,4-phenylene group or 4,4′-biphenylylene group; and Ar5 and Ar6 each independently represent a 2,6-naphthalenediyl group, 1,4-phenylene group, 1,3-phenylene group or 4,4′-biphenylylene group; provided that at least one group selected from the group consisting of the group represented by Ar4, the group represented by Ar5 and the group represented by Ar6 includes a 2,6-naphthalenediyl group; and hydrogen atoms in the groups represented by Ar4, Ar5 or Ar6 may each be independently substituted with a halogen atom, an alkyl group of 1 to 10 carbon atoms, or an aryl group of 6 to 20 carbon atoms.)

Examples of the halogen atom include a fluorine atom, chlorine atom, bromine atom and iodine atom. Further, the alkyl group may be linear, branched or cyclic, and preferred examples include a methyl group, ethyl group, propyl group, butyl group, hexyl group, octyl group and decyl group. Further, examples of the aryl group include a phenyl group and a naphthyl group.

By ensuring that the amount of 2,6-naphthalenediyl groups in the component (B), relative to the total amount of all groups represented by Ar4, Ar5 and Ar6, is at least 40 mol % but not more than 90 mol %, the dielectric loss of the liquid crystalline polyester liquid composition containing the component (B) can be reduced.

This amount of 2,6-naphthalenediyl groups, relative to the total amount of all groups represented by Ar4, Ar5 and Ar6, is preferably at least 50 mol % but not more than 85 mol %, more preferably at least 60 mol % but not more than 80 mol %, and even more preferably at least 70 mol % but not more than 75 mol %.

In another aspect, the amount of structural units containing a 2,6-naphthalenediyl group in the component (B), relative to the total amount of the structural unit (B1), the structural unit (B2) and the structural unit (B3), is at least 40 mol % but not more than 90 mol %, preferably at least 50 mol % but not more than 85 mol %, more preferably at least 60 mol % but not more than 80 mol %, and even more preferably at least 70 mol % but not more than 75 mol %.

By ensuring that the flow start temperature of the component (B) is at least 260° C., the heat resistance of the liquid crystalline polyester liquid composition containing the component (B) can be enhanced. This flow start temperature is preferably at least 280° C., more preferably at least 290° C., and even more preferably 295° C. or higher. If the flow start temperature is too high, then the molding temperature required to achieve melting must be increased, and thermal degradation becomes more likely, and therefore the flow start temperature is typically not higher than 380° C., and preferably 350° C. or lower.

In one aspect, the flow start temperature of the component (B) is preferably at least 260° C. but not higher than 380° C., more preferably at least 280° C. but not higher than 380° C., even more preferably at least 290° C. but not higher than 380° C. and particularly preferably at least 295° C. but not higher than 350° C.

Further, in another aspect, the flow start temperature of the component (B) may be at least 260° C. but not higher than 280° C., and may be at least 260° C. but not higher than 275° C.

Provided the flow start temperature of the component (B) falls within the above range, the heat resistance of the liquid crystalline polyester liquid composition can be enhanced, and the molding temperature is prevented from becoming too high, making thermal degradation less likely.

Here, the “flow start temperature” is measured using a capillary rheometer equipped with a die having an internal diameter of 1 mm and a length of 10 mm, and is the temperature at which the melt viscosity reaches 4,800 Pa-s when the liquid crystalline polyester is extruded from the nozzle under a loading of 9.8 MPa and at a rate of temperature increase of 4° C./minute (for example, see “Liquid Crystal Polymers—Synthesis ⋅ Molding—Applications”, edited by Naoyuki Koide, pages 95 to 105, published by CMC Publishing Co., Ltd., Jun. 5, 1987).

In the component (B), the structural unit (B1) is a structural unit derived from a prescribed aromatic hydroxycarboxylic acid.

The amount of the structural unit (B1), relative to the total amount of all the structural units that constitute the component (B), is preferably at least 30 mol % but not more than 80 mol %, more preferably at least 40 mol % but not more than 70 mol %, and even more preferably at least 45 mol % but not more than 65 mol %.

Further, the structural unit (B2) is a structural unit derived from a prescribed aromatic dicarboxylic acid.

The amount of the structural unit (B2), relative to the total amount of all the structural units that constitute the component (B), is preferably at least 10 mol % but not more than 35 mol %, more preferably at least 15 mol % but not more than 30 mol %, and even more preferably at least 17.5 mol % but not more than 27.5 mol %.

Furthermore, the structural unit (B3) is a structural unit derived from a prescribed aromatic diol.

The amount of the structural unit (B3), relative to the total amount of all the structural units that constitute the component (B), is preferably at least 10 mol % but not more than 35 mol %, more preferably at least 15 mol % but not more than 30 mol %, and even more preferably at least 17.5 mol % but not more than 27.5 mol %. Further, the amount of the structural unit (B2) and the amount of the structural unit (B3) are preferably substantially equal.

In one aspect, the component (B) in the present invention comprises the structural unit (B1), the structural unit (B2) and the structural unit (B3), and

relative to the total amount of all the structural units that constitute the component (B),

the amount of the structural unit (B) is at least 30 mol % but not more than 80 mol %, preferably at least 40 mol % but not more than 70 mol %, and more preferably at least 45 mol % but not more than 65 mol %,

the amount of the structural unit (B2) is at least 10 mol % but not more than 35 mol %, preferably at least 15 mol % but not more than 30 mol %, and more preferably at least 17.5 mol % but not more than 27.5 mol %, and

the amount of the structural unit (B3) is at least 10 mol % but not more than 35 mol %, preferably at least 15 mol % but not more than 30 mol %, and more preferably at least 17.5 mol % but not more than 27.5 mol %,

provided that the total amount of the structural unit (B1), the structural unit (B2) and the structural unit (B3) does not exceed 100 mol %.

In a typical example of a liquid crystalline polyester having high heat resistance and melt tension, for the structural unit (B1), the amount of a structural unit in which Ar4 is a 2,6-naphthalenediyl group, namely a structural unit derived from 6-hydroxy-2-naphthoic acid, relative to the total amount of all the structural units that constitute the component (B), is preferably at least 40 mol % but not more than 74.8 mol %, more preferably at least 40 mol % but not more than 64.5 mol %, and even more preferably at least 50 mol % but not more than 58 mol %.

For the structural unit (B2), the amount of a structural unit in which Ar5 is a 2,6-naphthalenediyl group, namely a structural unit derived from 2,6-naphthalenedicarboxylic acid, relative to the total amount of all the structural units that constitute the component (B), is preferably at least 10.0 mol % but not more than 35 mol %, more preferably at least 12.5 mol % but not more than 30 mol %, and even more preferably at least 15 mol % but not more than 25 mol %.

Further, for the structural unit (B2), the amount of a structural unit in which Ar5 is a 1,4-phenylene group, namely a structural unit derived from terephthalic acid, relative to the total amount of all the structural units that constitute the component (B), is preferably at least 0.2 mol % but not more than 15 mol %, more preferably at least 0.5 mol % but not more than 12 mol %, and even more preferably at least 2 mol % but not more than 10 mol %.

For the structural unit (B3), the amount of a structural unit in which Ar6 is a 1,4-phenylene group, namely a structural unit derived from hydroquinone, relative to the total amount of all the structural units that constitute the component (B), is preferably at least 12.5 mol % but not more than 30 mol %, more preferably at least 17.5 mol % but not more than 30 mol %, and even more preferably at least 20 mol % but not more than 25 mol %.

The component (B) can be produced by conducting a melt polycondensation of a monomer that yields the structural unit (1), namely a prescribed aromatic hydroxycarboxylic acid, a monomer that yields the structural unit (B2), namely a prescribed aromatic dicarboxylic acid, and a monomer that yields the structural unit (B3), namely a prescribed aromatic diol (provided that at least one monomer selected from the group consisting of the monomer that yields the structural unit (B1), the monomer that yields the structural unit (B2) and the monomer that yields the structural unit (B3) is a monomer having a 2,6-naphthalenediyl group), with the amount of monomer(s) having a 2,6-naphthalenediyl group set to at least 40 mol % but not more than 90 mol % relative to the total amount of all the monomers.

During this production, in order to enable the melt polycondensation to proceed rapidly, an ester-forming derivative is preferably used as each of the above monomers.

Here, examples of ester-forming derivatives, in the case of compounds having a carboxyl group, such as an aromatic hydroxycarboxylic acid or an aromatic dicarboxylic acid, include compounds in which the carboxyl group has been converted to a haloformyl group, compounds in which the carboxyl group has been converted to an acyloxycarbonyl group, and compounds in which the carboxyl group has been converted to an alkoxycarbonyl group or aryloxycarbonyl group.

Further, examples of ester-forming derivatives in the case of compounds having a hydroxyl group, such as an aromatic hydroxycarboxylic acid or an aromatic diol, include compounds in which the hydroxyl group has been converted to an acyloxy group. Among these compounds, compounds in which the hydroxyl group has been converted to an acyloxy group can be used favorably. In other words, an aromatic acyloxycarboxylic acid in which the hydroxyl group of an aromatic hydroxycarboxylic acid has been converted to an acyloxy group can be used favorably as the ester-forming derivative of the aromatic hydroxycarboxylic acid. Further, an aromatic diacyloxy compound in which the hydroxyl groups of an aromatic diol have been converted to acyloxy groups can be used favorably as the ester-forming derivative of the aromatic diol. The acylation is preferably an acetylation using acetic anhydride, and the ester-forming derivative obtained from this acetylation can undergo a deacetylation polycondensation.

The liquid crystalline polyester liquid composition of an embodiment of the present invention preferably comprises a powdered form of the component (B) dispersed in a resin solution of the component (A) dissolved in the component (S) described below.

Here, “dispersed” means a state in which the particles are dispersed in the composition without aggregating.

In this embodiment, from the viewpoint of preventing increases in the viscosity of the liquid crystalline polyester liquid composition, the volume average particle diameter of the component (B) is preferably at least 0.1 μm, more preferably at least 0.5 μm, and particularly preferably 1 μm or greater. Further, from the viewpoint of enhancing the copper foil peel strength and mechanical characteristics of a film produced using the liquid crystalline polyester liquid composition, the volume average particle diameter is preferably not more than 30 μm, more preferably not more than 25 μm, and particularly preferably 20 μm or less.

In one aspect, the volume average particle diameter of the component (B) is preferably at least 0.1 μm but not more than 30 μm, more preferably at least 0.5 μm but not more than 30 μm, particularly preferably at least 1 μm but not more than 25 μm, and most preferably at least 1 μm but not more than 20 μm.

In this description, the “volume average particle diameter” is the value of the particle diameter at the point where the cumulative volume reaches 50% (the 50% cumulative volume particle size D₅₀) in a volume-based cumulative particle size distribution curve, in which the total volume is deemed 100%, obtained by performing measurements using a scattering particle diameter distribution measurement device.

Examples of methods for controlling the particle diameter within the above range, for example when an impact mill is used, include altering the revolution rate of the milling blade, and altering the screen that is used. Further, when a jet mill is used, the rotational speed of the classification rotor can be altered.

The amount of the liquid crystalline polyester (B), relative to the sum total (the total amount) of the liquid crystalline polyester (A) and the liquid crystalline polyester (B) contained in the liquid crystalline polyester liquid composition, is preferably at least 5% by mass, more preferably at least 10% by mass, and particularly preferably 15% by mass or greater. Further, this sum total is preferably not more than 70% by mass, more preferably not more than 65% by mass, and even more preferably 60% by mass or less.

The above upper limit value and lower limit value may be combined as appropriate. In one embodiment of the present invention, from the viewpoint of enhancing the copper foil peel strength and mechanical characteristics of a film produced using the liquid crystalline polyester liquid composition, of the various options, the above sum total is preferably at least 10% by mass but not more than 60% by mass.

In another aspect, the amount of the liquid crystalline polyester (B), relative to the sum total (the total amount) of the liquid crystalline polyester (A) and the liquid crystalline polyester (B) contained in the liquid crystalline polyester liquid composition, may be at least 5% by mass but not more than 70% by mass, at least 10% by mass but not more than 70% by mass, or at least 15% by mass but not more than 60% by mass.

### <<Component (S)>>

In embodiments of the present invention, an aprotic solvent is a solvent that contains an aprotic compound.

In embodiments of the present invention, examples of the aprotic solvent include halogenated solvents such as 1-chlorobutane, chlorobenzene, 1,1-dichloroethane, 1,2-dichloroethane, chloroform and 1,1,2,2-tetrachloroethane, ether-based solvents such as diethyl ether, tetrahydrofuran and 1,4-dioxane, ketone-based solvents such as acetone and cyclohexanone, ester-based solvents such as ethyl acetate, lactone-based solvents such as γ-butyrolactone, carbonate-based solvents such as ethylene carbonate and propylene carbonate, amine-based solvents such as triethylamine and pyridine, nitrile-based solvents such as acetonitrile and succinonitrile, amide-based solvents such as N,N′-dimethylformamide. N,N′-dimethylacetamide, tetramethylurea and N-methylpyrrolidone, nitro-based solvents such as nitromethane and nitrobenzene, sulfide-based solvents such as dimethylsulfoxide and sulfolane, and phosphoric acid-based solvents such as hexamethylphosphoramide and tri-n-butylphosphoric acid.

Among these, the use of a solvent that does not contain halogen atoms is preferable from the perspective of environmental impact, and the use of a solvent for which the dipolar moment is at least 3 but not more than 5 is preferable from the viewpoint of solubility. Specifically, amide-based solvents such as N,N′-dimethylfonnamide, N,N′-dimethylacetamide, tetramethylurea and N-methylpyrrolidone, and lactone-based solvents such as γ-butyrolactone can be used particularly favorably, and N,N′-dimethylformamide, N,N′-dimethylacetamide or N-methylpyrrolidone is even more desirable.

In an embodiment of the present invention, the sum total (the total amount) of the liquid crystalline polyester (A) and the liquid crystalline polyester (B), per 100 parts by mass of the aprotic solvent (S), is preferably at least 0.01 parts by mass but not more than 100 parts by mass, more preferably at least 1 part by mass but not more than 70 parts by mass, and even more preferably at least 5 parts by mass but not more than 40 parts by mass.

In this embodiment, provided the sum total (the total amount) of the liquid crystalline polyester (A) and the liquid crystalline polyester (B) per 100 parts by mass of the aprotic solvent (S) falls within the above range, application to metal foils is possible. Consequently, the concentration may be adjusted appropriately within the above range in accordance with the desired thickness.

In another aspect, the amount of the component (S), relative to the total mass of the liquid crystalline polyester liquid composition, is preferably within a range from 75 to 95% by mass.

The liquid crystalline polyester liquid composition of an embodiment of the present invention can produce a film having a low dielectric loss tangent without impairing the adhesive strength to metal foils or the mechanical strength.

The component (A) is a component that enhances the adhesive strength to metal foils upon film formation, and also contributes to an improvement in the mechanical strength.

The component (B) is a component that exhibits excellent dielectric characteristics.

In embodiments of the present invention, it is thought that because the component (B) is dispersed in the liquid crystalline polyester liquid composition without dissolving in the component (S), the aforementioned characteristics of each component are able to manifest, and a combination of maintenance of the adhesive strength to metal foils, maintenance of mechanical strength, and favorable dielectric characteristics can be achieved.

It is thought that because both the component (A) and the component (B) are liquid crystalline polyester resins, although the components are not miscible, they do exhibit some compatibility at the interfaces between the component (A) and the component (B). Accordingly, it is thought that concentration of stress at the interfaces between the component (A) and the component (B) is reduced, enabling a combination of maintenance of the adhesive strength to metal foils, maintenance of mechanical strength, and favorable dielectric characteristics to be achieved.

### <Liquid Crystalline Polyester Film and Method for Manufacturing Liquid Crystalline Polyester Film>

One embodiment of the present invention is a liquid crystalline polyester film comprising a liquid crystalline polyester (A) that is soluble in an aprotic solvent and a liquid crystalline polyester (B) that is insoluble in an aprotic solvent, wherein the liquid crystalline polyester (B) is dispersed in the liquid crystalline polyester liquid composition. The liquid crystalline polyester film of this embodiment can be produced using the following method.

Here, “dispersed” means a state in which the particles are dispersed in the film without aggregating.

The liquid crystalline polyester film can be manufactured using a manufacturing method comprising flow casting the liquid crystalline polyester liquid composition of the present invention described above onto a support substrate (metal foil), obtaining a laminated body having the support substrate (metal foil) and a liquid crystalline polyester film precursor by removing the solvent from the liquid crystalline polyester liquid composition, and obtaining a laminated body having the support substrate (metal foil) and a liquid crystalline polyester film by subjecting the laminated body obtained following solvent removal to a heat treatment.

Examples of the method used for flow casting the above liquid crystalline polyester liquid composition into a film-like form include methods of flow casting the composition onto the support using any of various techniques such as roller coating methods, dip coating methods, spray coating methods, spin coating methods, curtain coating methods, slot coating methods and screen printing methods.

The support substrate is preferably a metal foil, and for example, a copper foil is preferable.

The thickness of the support substrate is preferably from 7 to 35 μm.

Further, although there are no particular limitations on the method used for removing the solvent, removal by evaporation of the solvent is preferable. Examples of methods of evaporating the solvent include methods that employ heating, reduced pressure or air blowing, but among these, from the viewpoints of improving the production efficiency and facilitating handling, evaporating the solvent by heating is preferable, and evaporating the solvent by heating while blowing air is more preferable. The heating conditions at this time (during solvent removal) preferably include conducting preliminary drying by heating at a temperature of at least 60° C. but not more than 200° C. for 10 minutes to 2 hours, and then conducting a heat treatment at a temperature of at least 200° C. but not more than 400° C. for 30 minutes to 5 hours.

Further, the heating conditions in the heat treatment used for obtaining the laminated body having the support substrate (metal foil) and the liquid crystalline polyester film preferably involve heating at 250 to 340° C. for 1 to 12 hours.

In one aspect, the liquid crystalline polyester liquid composition that represents one embodiment of the present invention comprises a liquid crystalline polyester (A) that is soluble in an aprotic solvent, a liquid crystalline polyester (B) that is insoluble in an aprotic solvent, and an aprotic solvent (S), wherein

the liquid crystalline polyester (A) has a structural unit derived from 6-hydroxy-2-naphthoic acid, a structural unit derived from isophthalic acid, and a structural unit derived from 4-hydroxyacetaminophen;

the liquid crystalline polyester (B) has a structural unit derived from 6-hydroxy-2-naphthoic acid, a structural unit derived from terephthalic acid, a structural unit derived from 2,6-naphthalenedicarboxylic acid, and a structural unit derived from hydroquinone;

the liquid crystalline polyester (B) is a powder having a volume average particle diameter of at least 1 μm but not more than 20 μm; and

the liquid crystalline polyester (B) is dispersed in the liquid crystalline polyester (A).

Moreover, the above liquid crystalline polyester liquid composition may be a liquid crystalline polyester liquid composition in which:

the amount of the liquid crystalline polyester (A), relative to the total mass of the liquid crystalline polyester liquid composition, is from 5 to 10% by mass;

the amount of the liquid crystalline polyester (B), relative to the total amount of the liquid crystalline polyester (A) and the liquid crystalline polyester (B) contained in the liquid crystalline polyester liquid composition, is at least 5% by mass but not more than 70% by mass;

the total amount of the liquid crystalline polyester (A) and the liquid crystalline polyester (B), per 100 parts by mass of the aprotic solvent (S), is at least 0.01 parts by mass but not more than 100 parts by mass;

relative to the amount of all the structural units that constitute the liquid crystalline polyester (A),

the amount of the structural unit (A1) is at least 30 mol % but not more than 80 mol %,

the amount of the structural unit (A2) is at least 10 mol % but not more than 35 mol %, and

the amount of the structural unit (A3) is at least 10 mol % but not more than 35 mol %,

provided that the total amount of structural units represented by the above formula (A1), structural units represented by the above formula (A2) and structural units represented by the above formula (A3) does not exceed 100 mol %;

relative to the amount of all the structural units that constitute the liquid crystalline polyester (B),

the amount of the structural unit (B1) is at least 0 mol % but not more than 80 mol %,

the amount of the structural unit (B2) is at least 10 mol % but not more than 35 mol %, and

the amount of the structural unit (B3) is at least 10 mol % but not more than 35 mol %,

provided that the total amount of the structural unit (B1), the structural unit (B2) and the structural unit (B3) does not exceed 100 mol %; and

the amount of structural units containing a 2,6-naphthalenediyl group, relative to the total amount of the structural unit (B1), the structural unit (B2) and the structural unit (B3), is at least 40 mol % but not more than 90 mol %.

One aspect of the present invention is a liquid crystalline polyester powder which comprises a structural unit derived from 2-hydroxy-6-naphthoic acid, a structural unit derived from 2,6-naphthalenedicarboxylic acid, a structural unit derived from terephthalic acid and a structural unit derived from hydroquinone, and has a volume average particle diameter of 9 μm.

One aspect of the present invention is a liquid crystalline polyester powder which is a polymer obtained by reacting a mixture containing 2-hydroxy-6-naphthoic acid (5.5 mol), 2,6-naphthalenedicarboxylic acid (1.75 mol), terephthalic acid (0.5 mol), hydroquinone (2.475 mol), acetic anhydride (12 mol), and 1-methylimidazole as a catalyst, and has a volume average particle diameter of 9 μm.

One aspect of the present invention is a liquid crystalline polyester powder having a volume average particle diameter of 9 μm, obtained by grinding a liquid crystalline polyester comprising a structural unit derived from 2-hydroxy-6-naphthoic acid, a structural unit derived from 2,6-naphthalenedicarboxylic acid, a structural unit derived from terephthalic acid and a structural unit derived from hydroquinone, and having a flow start temperature of 265° C.

One aspect of the present invention is a liquid crystalline polyester powder having a volume average particle diameter of 9 μm, obtained by grinding a polymer obtained by reacting a mixture containing 2-hydroxy-6-naphthoic acid (5.5 mol), 2,6-naphthalenedicarboxylic acid (1.75 mol), terephthalic acid (0.5 mol), hydroquinone (2.475 mol), acetic anhydride (12 mol), and 1-methylimidazole as a catalyst, the polymer having a flow start temperature of 265° C.

### EXAMPLES

### [Measurement of Flow Start Temperature of Liquid Crystalline Polyester]

Using a flow tester (model: CFT-500 manufactured by Shimadzu Corporation), about 2 g of the liquid crystalline polyester was packed in a cylinder equipped with a die having a nozzle with an internal diameter of 1 mm and a length of 10 mm, the liquid crystalline polyester was melted and extruded from the nozzle while the temperature was increased at a rate of 4° C./minute under a loading of 9.8 MPa (100 kg/cm²), and the temperature that yielded a viscosity of 4,800 Pa-s (48,000 P) was measured.

### [Measurement of Volume Average Particle Diameter of Liquid Crystalline Polyester Microparticles]

First, 0.01 g of the liquid crystalline polyester microparticles powder was weighed and dispersed in about 10 g of pure water. This dispersion of the liquid crystalline polyester microparticles powder was dispersed by irradiation with ultrasonic waves for 5 minutes. Using a scattering particle diameter distribution analyzer (LA-950V2 manufactured by Horiba, Ltd.), the volume average particle diameter of the liquid crystalline polyester mnicroparticles in the thus obtained dispersion of the liquid crystalline polyester microparticles powder was measured, using a value of 1.333 for the refractive index of pure water.

### [Measurement of Viscosity of Liquid Crystalline Polyester Solution]

Viscosity measurements were conducted using a B-type viscometer (TV-22 manufactured by Toki Sangyo Co., Ltd.).

### [Measurement of Tensile Strength of Liquid Crystalline Polyester Film]

The copper foil of a liquid crystalline polyester film single-sided copper-clad laminate was etched using a ferric chloride solution to obtain a single layer of the liquid crystalline polyester film. The maximum point stress, the elongation at break point, and the elastic modulus of the liquid crystalline polyester film were measured by cutting the film to prepare a tensile test No. 3 dumbbell having a parallel portion width of 5 mm and a length of 20 mm based on JIS K6251, and then conducting tensile testing using a tensile tester (Autograph AG-IS manufactured by Shimadzu Corporation) at a tension rate of 5 mm/minute in accordance with JIS K7161.

### [Measurement of Peel Strength of Liquid Crystalline Polyester Film Single-Sided Copper-Clad Laminate]

The liquid crystalline polyester film single-sided copper-clad laminate was cut into strips having a width of 10 mm to prepare three test pieces, the liquid crystalline polyester film of each test piece was secured, an Autograph (AG-1KNIS manufactured by Shimadzu Corporation) was used to measure the peel strength (also called the 90° peel strength) of the liquid crystalline polyester film single-sided copper-clad laminate by peeling the copper foil in a direction at an angle of 90° relative to the liquid crystalline polyester film at peel speed of 50 mm/minute, and the average value across the three test pieces was then calculated.

### [Measurement of Dielectric Constant and Dielectric Loss Tangent of Liquid Crystalline Polyester Film]

The copper foil of a liquid crystalline polyester film single-sided copper-clad laminate was etched using a ferric chloride solution. The thus obtained single layer of the liquid crystalline polyester film was melted at 350° C. using a flow tester (model CFT-500 manufactured by Shimadzu Corporation), and was then cooled and solidified to produce a tablet having a diameter of 1 cm and a thickness of 0.5 cm. Using an impedance analyzer (model E4991A manufactured by Agilent Technologies, Inc.), the dielectric constant and the dielectric loss tangent at 1 GHz for the obtained tablet were measured using the capacitance method.

### [Production Example for Liquid Crystalline Polyester (A)]

A reactor fitted with a stirrer, a torque meter, a nitrogen gas inlet tube, a thermometer and a reflux condenser was charged with 940.9 g (5.0 mol) of 6-hydroxy-2-naphthoic acid, 377.9 g (2.5 mol) of 4-hydroxyacetaminophen, 415.3 g (2.5 mol) of isophthalic acid and 867.8 g (8.4 mol) of acetic anhydride, and following flushing of the gas inside the reactor with nitrogen gas, the temperature was increased from room temperature (23° C.) to 140° C. over a period of 60 minutes under a stream of nitrogen gas and with constant stirring, and the contents were then refluxed at 140° C. for 3 hours. Subsequently, the temperature was increased from 150° C. to 300° C. over a period of 5 hours and then held at 300° C. for 30 minutes, while the by-product acetic acid and unreacted acetic anhydride were removed by distillation, and the contents were then extracted from the reactor and cooled to room temperature (23° C.). The obtained solid was ground in a grinder, thus obtaining a powdered liquid crystalline polyester (A-1). The flow start temperature of this liquid crystalline polyester (A-1) was 193.3° C.

The liquid crystalline polyester (A-1) was subjected to a solid phase polymerization under a nitrogen atmosphere by raising the temperature from room temperature (23° C.) to 160° C. over a period of 2 hours and 20 minutes, subsequently raising the temperature from 160° C. to 180° C. over a period of 3 hours and 20 minutes, and then holding the temperature at 180° C. for 5 hours, and the product was then cooled to room temperature (23° C.) and ground in a grinder to obtain a powdered liquid crystalline polyester (A-2). The flow start temperature of this liquid crystalline polyester (A-2) was 220° C.

The liquid crystalline polyester (A-2) was subjected to a solid phase polymerization under a nitrogen atmosphere by raising the temperature from room temperature (23° C.) to 180° C. over a period of 1 hour and 25 minutes, subsequently raising the temperature from 180° C. to 255° C. over a period of 6 hours and 40 minutes, and then holding the temperature at 255° C. for 5 hours, and the product was then cooled to 23° C. to obtain a powdered liquid crystalline polyester (A) having a volume average particle diameter of 871 μm. The volume average particle diameter of the liquid crystalline polyester (A) was measured using an RPS-105 manufactured by Seishin Enterprise Co., Ltd. The flow start temperature of the liquid crystalline polyester (A) was 302° C.

### [Preparation of Liquid Crystalline Polyester Solution (A′)]

Eight parts by mass of the liquid crystalline polyester (A) was added to 92 parts by mass of N-methylpyrrolidone (boiling point (1 atmosphere): 204° C.), and the mixture was stirred at 140° C. for 4 hours under a nitrogen atmosphere to prepare a liquid crystalline polyester solution (A′). The viscosity of this liquid crystalline polyester solution (A) was 955 mPa·s.

### [Production Example for Liquid Crystalline Polyester (B-1)]

A reactor fitted with a stirrer, a torque meter, a nitrogen gas inlet tube, a thermometer and a reflux condenser was charged with 1,034.99 g (5.5 mol) of 6-hydroxy-2-naphthoic acid, 378.33 g (1.75 mol) of 2,6-naphthalenedicarboxylic acid, 83.07 g (0.5 mol) of terephthalic acid, 272.52 g (2.475 mol, a 0.225 mol excess relative to the total molar amount of 2,6-naphthalenedicarboxylic acid and terephthalic acid) of hydroquinone, 1,226.87 g (12 mol) of acetic anhydride, and 0.17 g of 1-methylimidazole as a catalyst. Following flushing of the gas inside the reactor with nitrogen gas, the temperature was increased from room temperature to 145° C. over a period of 15 minutes under a stream of nitrogen gas with constant stirring, and the contents were then refluxed at 145° C. for 1 hour.

Subsequently, the temperature was increased from 145° C. to 310° C. over a period of 3 hours and 30 minutes, and then held at 310° C. for 3 hours, while the by-product acetic acid and unreacted acetic anhydride were removed by distillation, the resultant solid liquid crystalline polyester (B-1) was extracted, and this liquid crystalline polyester (B-1) was then cooled to room temperature (23° C.). The flow start temperature of this polyester (B-1) was 265° C.

### [Production of Liquid Crystalline Polyester Microparticles (B)]

Using a jet mill (KJ-200 manufactured by Kurimoto, Ltd.), the liquid crystalline polyester (B-1) was ground to obtain liquid crystalline polyester microparticles (B). The volume average particle diameter of these liquid crystalline polyester microparticles was 9 μm.

### [Preparation of Dispersions]

### Examples 1 to 5

The liquid crystalline polyester microparticles (B) were added in the blend amounts shown in Table 1 to the liquid crystalline polyester solution (A′) obtained above, and dispersions were prepared using a defoaming mixer (HM-500 manufactured by Keyence Corporation).

TABLE 1

| | Example 1 | Example 2 | Example 3 | Example 4 | Example 5 |
|---|---|---|---|---|---|
| Liquid crystalline polyester | 99.1 | 98 | 96.7 | 92.6 | 89.3 |
| solution (A′) | | | | | |
| parts by mass | | | | | |
| Liquid crystalline polyester | 0.9 | 2 | 3.3 | 7.4 | 10.7 |
| microparticles (B) | | | | | |
| parts by mass | | | | | |

### Comparative Examples 2 to 8

Silica microparticles (SO—C2 manufactured by Admatechs Co., Ltd., volume average particle diameter: 0.5 μm) were added in the blend amounts shown in Table 2 to the liquid crystalline polyester solution (A′) obtained above, and dispersions were prepared using a defoaming mixer (HM-500 manufactured by Keyence Corporation).

TABLE 2

| | Comparative | Comparative | Comparative | Comparative | Comparative | Comparative | Comparative |
|---|---|---|---|---|---|---|---|
| | Example 2 | Example 3 | Example 4 | Example 5 | Example 6 | Example 7 | Example 8 |
| Liquid crystalline | 99.4 | 98.6 | 97.6 | 94.8 | 88.3 | 83.9 | 77.1 |
| polyester solution (A′) | | | | | | | |
| parts by mass | | | | | | | |
| Silica microparticles | 0.6 | 1.4 | 2.4 | 5.2 | 11.7 | 16.1 | 22.9 |
| parts by mass | | | | | | | |

### Comparative Examples 9 to 13

Teflon (a registered trademark) microparticles (CEFRAL LUBE IP manufactured by Central Glass Co., Ltd., volume average particle diameter: 10 μm) were added in the blend amounts shown in Table 3 to the liquid crystalline polyester solution obtained above, and dispersions were prepared using a defoaming mixer (HM-500 manufactured by Keyence Corporation).

TABLE 3

| | Comparative | Comparative | Comparative | Comparative | Comparative |
|---|---|---|---|---|---|
| | Example 9 | Example 10 | Example 11 | Example 12 | Example 13 |
| Liquid crystalline polyester | 99.1 | 98.0 | 96.7 | 92.6 | 89.3 |
| solution (A′) | | | | | |
| parts by mass | | | | | |
| Teflon microparticles | 0.9 | 2.0 | 3.3 | 7.4 | 10.7 |
| parts by mass | | | | | |

### [Production of Liquid Crystalline Polyester Films]

Using a film applicator fitted with a micrometer (SA204 manufactured by TQC Sheen B.V.) and an automatic coating apparatus (model I manufactured by Tester Sangyo Co., Ltd.), the dispersions of Examples 1 to 5. Comparative Examples 2 to 13, and the liquid crystalline polyester solution (A′) containing no added microparticles as Comparative Example 1 were each flow cast onto the roughened surface of a copper foil (3EC-VLP manufactured by Mitsui Mining & Smelting Co., Ltd., 18 μm) in an amount sufficient to achieve a thickness for the flow cast film shown in Tables 4 to 6. Subsequently, drying was performed at 40° C. and normal pressure (1 atmosphere) for 4 hours to partially remove the solvent from the flow cast film.

In the case where flow casting was performed twice, the first flow casting was conducted and the film was dried under the drying conditions described above before the second flow casting and drying were conducted. The dried copper-clad films produced in Examples 1 to 5 and Comparative Examples 1 to 13 were each subjected to a heat treatment by heating from room temperature (23° C.) to 310° C. over a period of 4 hours, and then holding that temperature for 2 hours, in a hot circulation oven under a nitrogen atmosphere. As a result, heat-treated copper-clad films were obtained. These copper-clad films (also sometimes referred to as liquid crystalline polyester film single-sided copper-clad laminates) were measured for tensile strength, peel strength, dielectric constant and dielectric loss tangent, with the results shown in Tables 7 to 9.

TABLE 4

| | Example 1 | Example 2 | Example 3 | Example 4 | Example 5 |
|---|---|---|---|---|---|
| Flow cast film thickness (μm) | 260 | 240 | 220 | 280 | 240 |
| Flow casting repetitions | 2 | 2 | 2 | 1 | 1 |

TABLE 5

| | Comparative | Comparative | Comparative | Comparative | Comparative | Comparative | Comparative | Comparative |
|---|---|---|---|---|---|---|---|---|
| | Example 1 | Example 2 | Example 3 | Example 4 | Example 5 | Example 6 | Example 7 | Example 8 |
| Flow cast film | 300 | 280 | 260 | 240 | 220 | 300 | 280 | 260 |
| thickness | | | | | | | | |
| (μm) | | | | | | | | |
| Flow casting | 2 | 2 | 2 | 2 | 2 | 1 | 1 | 1 |
| repetitions | | | | | | | | |

TABLE 6

| | Comparative | Comparative | Comparative | Comparative | Comparative |
|---|---|---|---|---|---|
| | Example 9 | Example 10 | Example 11 | Example 12 | Example 13 |
| Flow cast | 260 | 240 | 220 | 300 | 280 |
| film thickness (μm) | | | | | |
| Flow casting | 2 | 2 | 2 | 1 | 1 |
| repetitions | | | | | |

TABLE 7

| | | Comparative | Example | Example | Example | Example | Example |
|---|---|---|---|---|---|---|---|
| | | Example 1 | 1 | 2 | 3 | 4 | 5 |
| Mechanical | Maximum point | 138 | 125 | 120 | 123 | 121 | 117 |
| properties | stress [MPa] | | | | | | |
| | Elongation at | 22 | 17 | 14 | 12 | 9 | 8 |
| | break point [%] | | | | | | |
| | Elastic modulus | 4.6 | 4.1 | 4.1 | 4.7 | 4.3 | 4.8 |
| | [GPa] | | | | | | |
| | Peel strength | 13.4 | 11.1 | 12.5 | 11.5 | 9.7 | 10.2 |
| Dielectric | Dielectric | 2.8 | 2.8 | 2.9 | 2.9 | 2.9 | 2.8 |
| characteristics | constant | | | | | | |
| | Dielectric loss | 0.0028 | 0.0025 | 0.0024 | 0.0025 | 0.0020 | 0.0016 |
| | tangent | | | | | | |

TABLE 8

| | | Comparative | Comparative | Comparative | Comparative | Comparative | Comparative | Comparative |
|---|---|---|---|---|---|---|---|---|
| | | Example 1 | Example 2 | Example 3 | Example 4 | Example 5 | Example 6 | Example 7 |
| Mechanical | Maximum point | 138 | 116 | 109 | 109 | 102 | 88 | 65 |
| properties | stress [MPa] | | | | | | | |
| | Elongation at | 22 | 12.6 | 9.8 | 6.8 | 2 | 1.1 | 0.6 |
| | break point [%] | | | | | | | |
| | Elastic modulus | 4.6 | 5.5 | 5.1 | 5.6 | 7.4 | 10 | 10.1 |
| | [GPa] | | | | | | | |
| | Peel strength | 13.4 | 9.0 | 9.0 | 6.5 | 7.2 | 5.0 | 3.0 |
| Dielectric | Dielectric | 2.8 | 2.8 | 2.9 | 2.9 | 3.0 | 3.1 | 3.1 |
| characteristics | constant | | | | | | | |
| | Dielectric loss | 0.0028 | 0.0027 | 0.0025 | 0.0024 | 0.0020 | 0.0014 | 0.0012 |
| | tangent | | | | | | | |

TABLE 9

| | | Comparative | Comparative | Comparative | Comparative | Comparative | Comparative |
|---|---|---|---|---|---|---|---|
| | | Example 8 | Example 9 | Example 10 | Example 11 | Example 12 | Example 13 |
| Mechanical | Maximum point | 25 | 95 | 83 | 75 | 43 | 35 |
| properties | stress [MPa] | | | | | | |
| | Elongation at | 0.3 | 9.0 | 9.1 | 9.7 | 4.9 | 4.7 |
| | break point [%] | | | | | | |
| | Elastic modulus | 8.8 | 4.4 | 3.6 | 3.3 | 2.5 | 2.2 |
| | [GPa] | | | | | | |
| | Peel strength | 2.2 | 10.3 | 8.1 | 8.8 | 6.2 | 4.2 |
| Dielectric | Dielectric | 3.1 | 2.4 | 2.3 | 2.4 | 2.2 | 2.1 |
| characteristics | constant | | | | | | |
| | Dielectric loss | 0.0010 | 0.0018 | 0.0016 | 0.0017 | 0.0014 | 0.0009 |
| | tangent | | | | | | |

As illustrated by the above results, compared with Comparative Examples 1 to 13, Examples 1 to 5 that applied the present invention had a low dielectric loss tangent, without impairment of the adhesive strength to metal foils or the mechanical strength.

### INDUSTRIAL APPLICABILITY

The present invention can provide a liquid crystalline polyester liquid composition capable of producing a film having a low dielectric loss tangent without impairing the adhesive strength to metal foils or the mechanical strength, a method for manufacturing a liquid crystalline polyester film, and a liquid crystalline polyester film, and is therefore extremely useful industrially.

1. A liquid crystalline polyester liquid composition comprising a liquid crystalline polyester (A) that is soluble in an aprotic solvent, a liquid crystalline polyester (B) that is insoluble in an aprotic solvent, and an aprotic solvent (S), wherein
the liquid crystalline polyester (A) and the liquid crystalline polyester (B) are liquid crystalline polyesters that have a structural unit derived from a hydroxycarboxylic acid as a mesogenic group.

2. The liquid crystalline polyester liquid composition according to claim 1, wherein the liquid crystalline polyester (A) and the liquid crystalline polyester (B) each contain a structural unit derived from p-hydroxybenzoic acid or 6-hydroxy-2-naphthoic acid.

3. The liquid crystalline polyester liquid composition according to claim 1, wherein the liquid crystalline polyester (A) contains a structural unit represented by formula (A1) shown below, a structural unit represented by formula (A2) shown below, and a structural unit represented by formula (A3) shown below, and
relative to a total amount of all structural units that constitute the liquid crystalline polyester (A), an amount of the structural unit represented by formula (A1) is at least 30 mol % but not more than 80 mol %, an amount of the structural unit represented by formula (A2) is at least 10 mol % but not more than 35 mol %, and an amount of the structural unit represented by formula (A3) is at least 10 mol % but not more than 35 mol %:
—O-Ar1-CO— (A1)
—CO-Ar2-CO— (A2)
—X-Ar3-Y— (A3)
wherein Ar1 represents a 1,4-phenylene group, 2,6-naphthalenediyl group or 4,4′-biphenylene group, Ar2 represents a 1,4-phenylene group, 1,3-phenylene group or 2,6-naphthalenediyl group, Ar3 represents a 1,4-phenylene group or 1,3-phenylene group, X represents —NH—, and Y represents —O— or NH—.

4. The liquid crystalline polyester liquid composition according to claim 1, wherein the liquid crystalline polyester (B) contains a naphthalene structure in a structural unit.

5. The liquid crystalline polyester liquid composition according to claim 1, wherein the liquid crystalline polyester (B) contains a structural unit represented by formula (B1) shown below, a structural unit represented by formula (B2) shown below, and a structural unit represented by formula (B3) shown below,
at least one structural unit selected from the group consisting of the structural unit represented by formula (B1), the structural unit represented by formula (B2) and the structural unit represented by formula (B3) contains a naphthalene structure,
the naphthalene structure is a 2,6-naphthalenediyl group, and
an amount of 2,6-naphthalenediyl groups, relative to a total amount of all groups represented by Ar4, Ar5 and Ar6 shown below, is at least 40 mol %:
—O-Ar4-CO— (B1)
—CO-Ar5-CO— (B2)
—O-Ar6-O— (B3)
wherein Ar4 represents a 2,6-naphthalenediyl group, 1,4-phenylene group or 4,4′-biphenylylene group; Ar5 represents a 2,6-naphthalenediyl group, 1,4-phenylene group, 1,3-phenylene group or 4,4′-biphenylylene group; and Ar6 represents a 2,6-naphthalenediyl group, 1,4-phenylene group, 1,3-phenylene group or 4,4′-biphenylylene group; provided that at least one group selected from the group consisting of the group represented by Ar4, the group represented by Ar5 and the group represented by Ar6 includes a 2,6-naphthalenediyl group; and hydrogen atoms in the groups represented by Ar4, Ar5 or Ar6 may each be independently substituted with a halogen atom, an alkyl group of 1 to 10 carbon atoms, or an aryl group of 6 to 20 carbon atoms.

6. The liquid crystalline polyester liquid composition according to claim 1, wherein Ar1 is a 2,6-naphthylene group, Ar2 is a 1,3-phenylene group, Ar3 is a 1,4-phenylene group, and Y is —O—.

7. The liquid crystalline polyester liquid composition according to claim 1, wherein an amount of the liquid crystalline polyester (B), relative to a total amount of the liquid crystalline polyester (A) and the liquid crystalline polyester (B) contained in the liquid crystalline polyester liquid composition, is at least 5% by mass but not more than 70% by mass.

8. The liquid crystalline polyester liquid composition according to claim 1, wherein a total amount of the liquid crystalline polyester (A) and the liquid crystalline polyester (B), per 100 parts by mass of the aprotic solvent (S), is at least 0.01 parts by mass but not more than 100 parts by mass.

9. The liquid crystalline polyester liquid composition according to claim 1, wherein the aprotic solvent (S) is N-methylpyrrolidone.

10. The liquid crystalline polyester liquid composition according to claim 1, wherein the liquid crystalline polyester (B) is a powder having a volume average particle diameter of at least 0.1 μm but not more than 30 μm.

11. A method for manufacturing a liquid crystalline polyester film, comprising
flow casting the liquid crystalline polyester liquid composition according to claim 1 onto a metal foil,
obtaining a laminated body having the metal foil and a liquid crystalline polyester film precursor by removing the solvent from the flow cast liquid crystalline polyester liquid composition, and
obtaining a laminated body having the metal foil and a liquid crystalline polyester film by subjecting the laminated body obtained following solvent removal to a heat treatment.

12. A liquid crystalline polyester film comprising a liquid crystalline polyester (A) that is soluble in an aprotic solvent and a liquid crystalline polyester (B) that is insoluble in an aprotic solvent, wherein the liquid crystalline polyester (B) is dispersed in the liquid crystalline polyester (A).
